(19) United States
(12) Patent Application Publication
(10) Pub. No.: US 2025/0210752 A1
(43) Pub. Date: Jun. 26, 2025

(54) PREFORMED INSERT FOR BATTERY MODULE

(71) Applicant: GM GLOBAL TECHNOLOGY OPERATIONS LLC, Detrolt, MI (US)

(72) Inventors: Chinmaya Patil, South Lyon, MI (US); Miguel Arturo Saez, Clarkston, MI (US); John P. Spicer, Plymouth, MI (US); Madhusudan Raghavan, West Bloomfield, MI (US); Christopher D. Cogan, Clarkston, MI (US); Ronald Wahl, Oakland, MI (US); Jeff Jadike, Washington Township, MI (US)

(73) Assignee: GM GLOBAL TECHNOLOGY OPERATIONS LLC, Detroit, MI (US)

(21) Appl. No.: 18/396,080

(22) Filed: Dec. 26, 2023

(51) Int. Cl. H01M 10/6556; B60K 6/28; B60L 50/60; H01M 10/613; H01M 10/625; H01M 10/653; H01M 50/213; H01M 50/505

(52) U.S. Cl. CPC H01M 10/6556; B60L 50/60; H01M 10/613; H01M 10/625; H01M 10/653; H01M 50/213; H01M 50/505; B60K 6/28; B60Y 2200/92; B60Y 2306/05; B60Y 2400/112; H01M 2220/20

(57) ABSTRACT

A battery module having a preformed insert. The battery module may include a plurality of battery cells configured for storing and supplying electrical power and a cell holder configured for supporting the battery cells. The preformed insert may be disposed relative to the cell holder and the battery cells and formed to include a potting material shaped to define a plurality of coolant channels around the battery cells.

### INTRODUCTION

The present disclosure relates to cooling battery cells, such as but not necessarily limited to cooling battery cells included within a battery module for purposes of storing and supplying electrical power for a vehicle.

A rechargeable energy storage system (RESS) may be configured for storing and supplying electrical power for a wide variety of applications, with one of the more common types of RESSs including a plurality of battery cells arranged into one or more battery modules. Such an RESS may be included onboard a vehicle to store and supply electrical power for a main or a high voltage (HV) bus and/or an auxiliary or a low voltage (LV) bus. Because the battery cells tend to generate heat when storing and supplying electrical power, it may be advantageous for the associated battery module to be operate with a cold plate or other external element of a cooling system to conduct thermal energy away from the battery modules. Such a cooling system may include a static epoxy filler or other solidifying fluid to provide fixed thermal pathways of immovable material to facilitate conducting thermal energy away from the battery cells. The use of such fillers may be problematic due to the fillers generally requiring multiple manufacturing steps or processes, including those associated with pouring the filler material into the battery module around the battery cells, sealing the battery module or otherwise limiting the filler material from seeping into undesirable areas, and proofing, and in some cases heating, time needed to allow the poured filler to solidify.

### SUMMARY

One aspect of the present disclosure relates to a preformed insert operable for conducting thermal energy away from battery cells without having to pour a filler or other solidifying material into an associated battery module or otherwise undertake labor and time consuming manufacturing process. The preformed insert may be formed out of a potting material shaped to define cavities for receiving the battery cells and cooling channels for cycling coolant relative thereto. The battery cells may be simply press-fit or otherwise inserted within the cavities and cooling fluid may thereafter be cycled through the cooling channels to conduct thermal energy away from the battery cells. The capability to cycle coolant through the coolant channels may be advantageous relative to thermal pathways having fixed or immovable fillers due to the cycling of coolant tending to provide greater thermal distribution and efficiency.

One aspect of the present disclosure relates to a battery module. The battery module may include a plurality of battery cells configured for storing and supplying electrical power, a cell holder configured for supporting the battery cells, and a preformed insert disposed relative to the cell holder and the battery cells. The preformed insert may include a potting material shaped to define a plurality of coolant channels around the battery cells.

The preformed insert may include a plurality of cell cavities interspersed with the coolant channels, optionally with the cell cavities shaped within the potting material to laterally surround a respective one of the battery cells.

The preformed insert may include a two-piece construction having an upper part preformed separately from a lower part and an interlock configured for attaching the upper part to the lower part.

The cell cavities may include an upper end proximate a top of the battery cells and a lower end proximate a bottom of the battery cells.

The preformed insert may be configured to provide an upper interference fit between the upper ends and the top of the battery cells and a lower interference fit between the lower ends and the bottom of the battery cells.

The upper and lower interference fits may be provided with respective upper and lower protuberances formed within the potting material.

The upper and lower interference fits may be provided with respective upper and lower o-rings and/or gaskets disposed within the potting material.

The preformed insert may include a plurality of coolant ribbons disposed within the coolant channels, optionally with the coolant ribbons defining coolant passageways for coolant to flow through the coolant channels.

The preformed insert may include a thermal interface material disposed between the coolant ribbons and the battery cells, optionally with the thermal interface material configured for supporting thermal conductivity between the coolant ribbons and the battery cells.

The potting material may include a thermally conductive material having a closed-cell foam structure.

The cell cavities may include an upper end proximate a top of the battery cells, a lower end proximate a bottom of the battery cells, and a middle portion between the upper and lower ends, optionally with the upper and lower ends narrower than the middle portions and the middle portions define the coolant channels.

The battery cells may be arranged into a plurality of rows, and the coolant channels may be shaped such that the middle portions of the cavities in each respective row fluidly interconnect.

The cell holder may include a coolant inlet and a coolant outlet, wherein the coolant inlets and outlets fluidly interconnect with respective middle portions of the cell cavities.

One aspect of the present disclosure relates to a method for manufacturing a battery module. The method may include receiving a cell holder, receiving a plurality of battery cells, positioning a preformed insert within the cell holder, the preformed insert including a potting material formed to define a plurality of cell cavities interspersed relative to a plurality of coolant channels, and pressing the battery cells into a respective one of the cell cavities.

The method may include forming the preformed insert such that the cell cavities include an upper end, a lower end, and a middle portion between the upper and lower ends, optionally with the upper and lower ends being narrower than the middle portions and the middle portions defining the coolant channels.

The method may include forming the preformed insert such that the battery cells are arranged into a plurality of rows and the middle portions of the cavities in each respective row fluidly interconnect with each other to define the coolant channels.

The method may include forming the preformed insert out of a thermally conductive material having a closed-cell foam structure.

The method may include securing the battery cells within the preformed insert and securing the preformed insert within the cell holder without use of a poured epoxy or a fluid adhesive.

One aspect of the present disclosure relates to a vehicle. The vehicle may include an electric motor configured for converting electrical power to mechanical power suitable for use in propelling the vehicle and a rechargeable energy storage system (RESS) having one or more energy modules configured for storing and supplying the electrical power. The energy modules may respectively include a plurality of energy cells configured for storing and supplying the electrical power, a cell holder configured for supporting the energy cells, a preformed insert having a potting material shaped to define a plurality of cell cavities for receiving the energy cells and a plurality of coolant channels for defining passageways for coolant to flow between the cell cavities relative to the energy cells, a busbar configured for electrically interconnect the energy cells, optionally with the busbar connecting to a portion of the energy cells extending beyond a top surface of the preformed insert, and a coolant system configured for cycling the coolant through the coolant channels to facilitate conducting thermal energy away from the energy cells.

The energy cells may be cylindrically shaped battery cells, and the potting material is molded from thermally conductive material having a closed-cell foam structure.

The cell cavities may be through-holes shaped to include an upper end, a lower end, and a middle portion, optionally with the upper and lower ends being narrower than the middle portions and the middle portions defining the coolant channels.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a vehicle in accordance with one non-limiting aspect of the present disclosure.

FIG. 2 illustrates a partial exploded view of a battery module in accordance with one non-limiting aspect of the present disclosure.

FIG. 3 illustrates a partial cutaway perspective view of a preformed insert in accordance with one non-limiting aspect of the present disclosure.

FIG. 4 illustrates a perspective view of a battery module in accordance with one non-limiting aspect of the present disclosure.

FIG. 5 illustrates a schematic side view of the battery module of FIG. 4 with the preformed insert having an interlock in accordance with one non-limiting aspect of the present disclosure.

FIG. 6 illustrates an alternative schematic side view of the battery module of FIG. 4 in accordance with one non-limiting aspect of the present disclosure.

FIG. 7 illustrates an alternative schematic side view of the battery module of FIG. 4 with the preformed insert having coolant ribbons in accordance with one non-limiting aspect of the present disclosure.

FIG. 8 illustrates a flowchart of a method for manufacturing a battery module in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

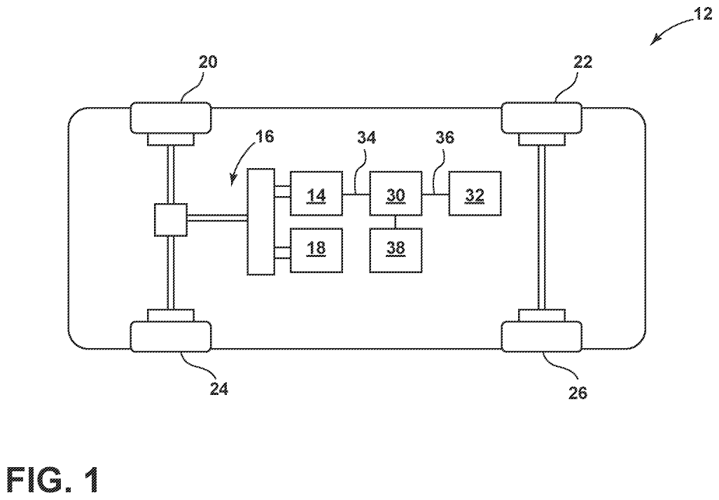

FIG. 1 illustrates a vehicle 12 in accordance with one non-limiting aspect of the present disclosure. The vehicle 12, which may be interchangeable referred to as an electric or hybrid vehicle 12, may include a traction motor 14 operable for converting electrical power to mechanical power for purposes of performing work, such as for mechanically powering a drivetrain 16 to propel the vehicle. The vehicle 12 is illustrated as a hybrid type due to the powertrain 16 optionally including an internal combustion engine (ICE) 18 for generating mechanical power. The vehicle 12 may alternatively omit the electric motor 14 and instead be solely propelled with the ICE 18. The powertrain 16 may include componentry to facilitate conveying rotative force from the traction motor 14 and/or the ICE 18 to one or more of the wheels 20, 22, 24, 26. The vehicle 12 may include a rechargeable energy storage system (RESS) 30 configured to store and supply electrical power for the traction motor 12 and/or other components, systems, etc. 32 onboard the vehicle 12, such as via a first bus 34 and a second bus 36. The vehicle 12 may include a vehicle controller 38 to facilitate monitoring, controlling, measuring, and otherwise directing operation, performance, etc. onboard the vehicle 12, which may include performing measurements, taking readings, or otherwise collecting data to facilitate diagnosing constraining events and correspondingly managing the RESS 30 to mitigate the influence thereof while maintaining operation of the RESS 30 within defined operating boundaries.

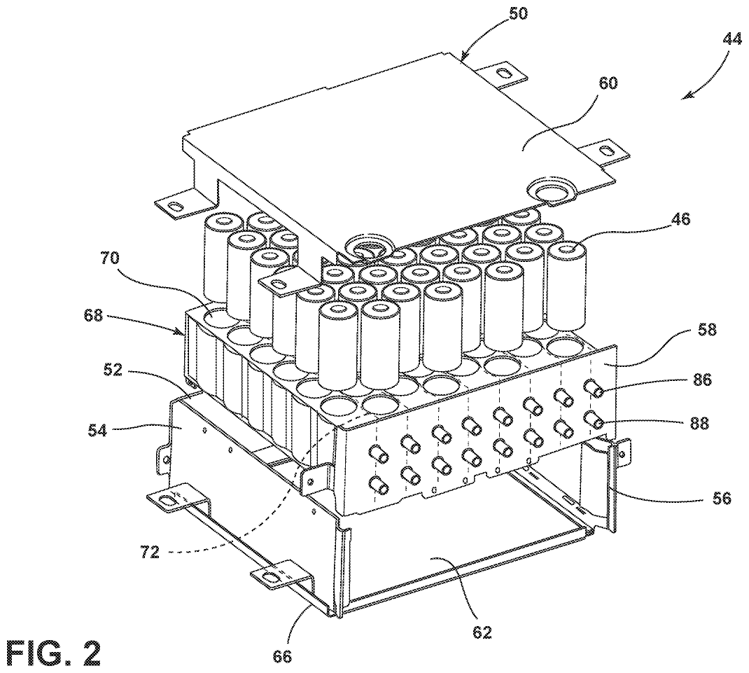

FIG. 2 illustrates a partial exploded view of a battery module in accordance with one non-limiting aspect of the present disclosure. The battery module 44 may be included as a part of the RESS 30 to house a plurality of battery cells 46 operable for storing and supplying electrical power. The RESS is shown with respect to including a single battery module 44 for presentation simplicity as the present disclosure fully contemplates the RESS including additional battery modules 44, including battery modules 44 having more or less than the illustrated quantity of battery cells 46. The battery module 44 may include additional componentry for electrically interconnecting the battery cells 46 to each other and/or other system onboard the vehicle 12. The battery cells 46 may be comprised of a wide variety of components operable for storing and supplying electrical power. The battery cells 46 may include a lithium-ion material or other material chemistry suitable for storing and supplying electrical power, optionally with some of the battery cells 46 having mixed or different chemistries than some of the other battery cells 46. The use of battery cells 46, however, is presented for non-limiting purposes as the present disclosure fully contemplates the battery cells 46 being other types of energy cells capable of storing and/or supplying electrical power, such as but not necessarily limited to energy cells comprised of capacitors, supercapacitors, fuel cells, or other types of energy components.

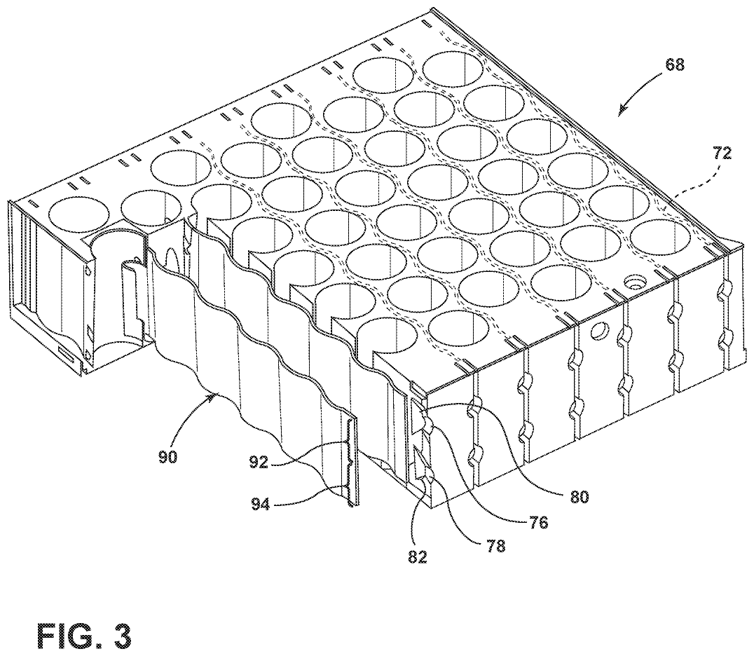

The battery module 44 may include a cell holder 50 configured for supporting the battery cells 46. The cell holder 50 may be formed as a rigid construction, such as out of a plurality of stamped or molded materials assembled into a housing or other structure suitable for enclosing the battery cells 46. The cell holder 50 is shown for non-limiting purposes as including four side pieces 52, 54, 56, 58 and oppose top and bottom pieces 60, 62 that may be interconnected, welded, fastened, or otherwise attached to each other. The bottom piece 62 may have an underside resting against or otherwise cooperate with a cold plate 66 or other element of a cooling system (not shown). One aspect of the present disclosure relates to a preformed insert 68 being included within the battery module 44. The preformed insert 68 may be operable for conducting thermal energy away from battery cells 46 without having to pour a filler or other solidifying material into an associated battery module 44 or otherwise undertake labor and time consuming manufacturing processes. As shown in the partial cutaway perspective view of the shown in FIG. 3, the preformed insert 68 may be formed out of a potting material shaped to define cavities 70 for receiving the battery cells 46 and coolant channels 72 for cycling a dielectric or other suitable coolant provided via the cooling system relative to the battery cells 46. The battery cells 46 may be press-fit or otherwise inserted within the cavities 70 and cooling fluid may thereafter be cycled through the coolant channels 72 to conduct thermal energy away from the battery cells 46. The capability to cycle coolant through the coolant channels 72 (which are not individually labeled and are instead shown with representative dashed lines for presentation simplicity) may be advantageous relative to thermal pathways having fixed or immovable fillers due to the cycling of coolant tending to provide greater thermal distribution and efficiency.

The preformed insert 68 may include the cell cavities 70 arranged according to a plurality of rows and columns, optionally with the coolant channels 72 in each row being fluidly interconnected. The preformed insert 68 may include a coolant inlet 76 and a coolant outlet 78 for each of the coolant channels 72, which may optionally include a cone or other shaped expansion element 80, 82 for dispersing coolant therethrough. Returning to FIG. 2, the coolant inlets and outlets 76, 78 may cooperate with inlet and outlet coolant ports 86, 88 (which are not each individual labeled) included within the cell holder 50 to facilitate fluidly connecting the coolant inlets and outlets 80, 82 with the cooling system. As shown in FIG. 3 with a partial cutaway, the preformed insert 68 may optionally include a coolant ribbon 90 disposed within one or more of the coolant channels 72. The coolant ribbons 90 may be rigid structures for defining coolant passageways for coolant to flow through the coolant channels 72. The coolant ribbons 90 may be divided into an upper section 92 and a lower section 94 such that coolant fluid may be delivered through a respective one of the coolant inlets 76 for communication through the upper section 92, with the coolant thereafter traveling to a rearward end of the associated coolant ribbon 90 whereat it may reverse direction to flow back towards a respective coolant outlet 78 positioned proximate to the associated lower section 94. The material used to form the preformed insert 68 may be comprised of a thermally conductive material having a closed-cell foam structure or other type of material suitable for thermally conducting energy away from the battery cells 46. The potting material may be semi-rigid or less rigid than the housing and/or the coolant ribbons 90. The potting material may be sufficiently dense and/or stiff to facilitate press-fitting with the battery cells 46 and/or otherwise supporting the battery cells 46 in the manner contemplated herein.

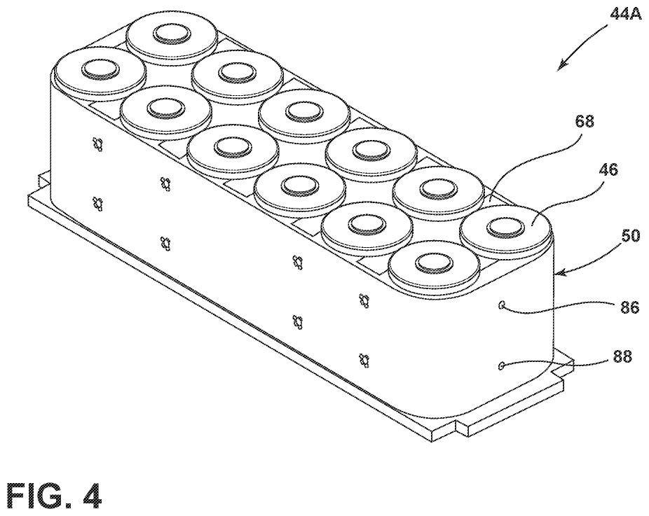

FIG. 4 illustrates a perspective view of a battery module in accordance with one non-limiting aspect of the present disclosure. The battery module 44A may be similar to that described above with respect to including a cell holder 50 and a plurality of battery cells 46 position within a preformed insert 68. The battery module 44A is shown to include less battery cells 46 in the battery module 44 described above in order to demonstrate advantageous capabilities of the present disclosure to support a modular construction whereby multiples of the battery cells 46 monitor modules may be joined together to form the RESS 30, such as with multiple modules being operable together in series and/or in parallel. The capability to selectively interconnect multiple battery modules 44A may be advantageous in tailoring the size, capacity, etc. of the RESS 30 to the vehicle and/or other device employing the use thereof. One aspect of the present disclosure contemplates the preformed insert 68 having differing configurations depending on a desired manner for cycling coolant through the coolant channels 72. The capability to cycle coolant through the coolant channels 72 may be advantageous in providing an immersive type of cooling environment whereby a coolant may be cycled relative to the battery cells 46, and optionally in contact with the battery cells 46, so as to maximize optimize thermal conductivity and cooling. As one skilled in the art may appreciate, the capability to provide improved cooling over static or immovable fillers may be advantageous in limiting operating temperatures for the RESS 30, which may in turn improve battery cell 46 performance, efficiency, longevity, etc.

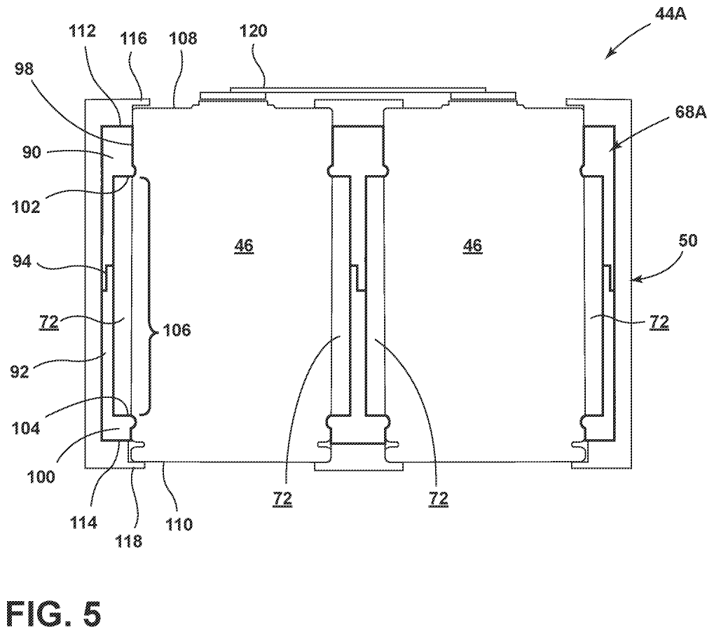

FIG. 5 illustrates a partial schematic side view taken from FIG. 4 to illustrate the preformed insert 68A having an interlocked configuration in accordance with one non-limiting aspect of the present disclosure. The interlocked configuration may correspond with the preformed insert 68A having a two-piece construction, with an upper part 90 preformed separately from a lower part 92 and an interlocked 94 configured for attaching the upper part 90 to the lower part 92. The interlocked 94 may include features suitable for sealing, connecting, or otherwise attaching the upper lower parts together such that coolant falling through the respective coolant channels 72 may be retained therein. The interlocked 94 may be operable to permit the lower part 92 to be inserted within the cell holder 50 so that the battery cells 46 may be inserted into respective one of the battery cavities 70 whereafter the upper part 90 may be assembled thereover. The interlock 94 may also be operable to permit the lower part 90 to be inserted within the cell holder 50 so that the upper part 90 may be assembled thereover whereafter the battery cells 46 may be fitted into the cell cavities 70 after the preformed insert 68A is assembled. The cell cavities 70 may include an upper end 98 proximate a top of the battery cells 46 and a lower end 100 proximate a bottom of the battery cells 46.

The preformed insert 68A may include upper and lower protuberances 102, 104 configured to provide an upper interference fit between the upper end 98 and the top of the battery cells 46 and a lower interference fit between the lower end 100 and the bottom of the battery cells 46. The interference fits may be operable for retaining coolant within the respective coolant channels 72. The upper and lower ends 98,100 of the cell cavities 70 may be narrower than a middle portion 106 such that the middle portion 106 may be used to define the respective coolant channels 72. The preformed potting material forming the preformed insert 68A may be shaped to at least partially or entirely surround the battery cells 46 laterally such that the cell cavities 70 may be interspersed relative to the coolant channels 72. The cell cavities 70 may interconnect with or form part of the coolant channels 72 that the coolant cycling through the coolant channels 72 may physically contact the sides of the battery cell 46 before passing through a tunneled section connecting to another one of the cell cavities 70. The cell cavities 70 may be through-holes shaped such that a top surface 108 and a bottom surface 110 of the battery cells 46 may extend beyond corresponding a top surface 112 and a bottom surface 114 of the preformed insert 68A. The cell holder 50 may be correspondingly shaped such that a top extension 116 and a bottom extension 118 may be shaped to extend at least partially over the battery cells 46. A busbar or other circuit componentry 120 may be included for electrically interconnecting the battery cells 46 with each other.

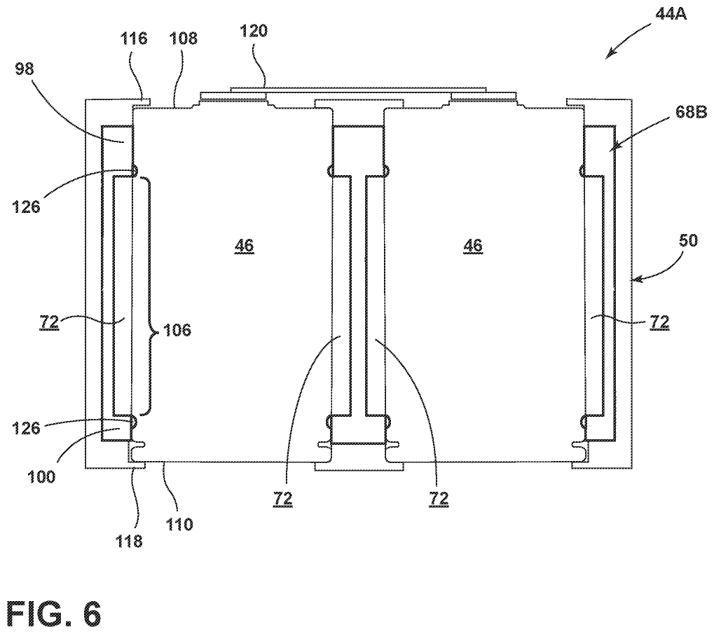

FIG. 6 illustrates a partial schematic side view taken from FIG. 4 to illustrate the preformed insert 68B having a unitary configuration in accordance with one non-limiting aspect of the present disclosure. The unitary configuration may be characterized by the preformed insert 68B insert having one-piece construction. The unitary configuration is shown to include seals 126, e.g., O-rings and/or gaskets, to provide an upper interference fit between the upper end 98 and the top of the battery cells 46 and a lower interference fit between the lower end 100 and the bottom of the battery cells 46. The seals 126 may be formed out of rubber or other material different from the potting material and used in place of the above-described upper and lower protuberances to ameliorate tolerancing requirements, forming controls, and/or other processes needed to form the protuberances. In other words, rather than closely shaping the preformed insert 68B to include the protuberances, the preformed insert 68B may instead be shaped to include reliefs within which the seals may be disposed to seal the respective coolant channels 72. One aspect of the present disclosure contemplates the seals 126 having an elastic or spring property such that the seals 126 may be slightly compressed for insertion within the respective cell cavity 70 whereafter the seal may slightly expand to retain itself therein.

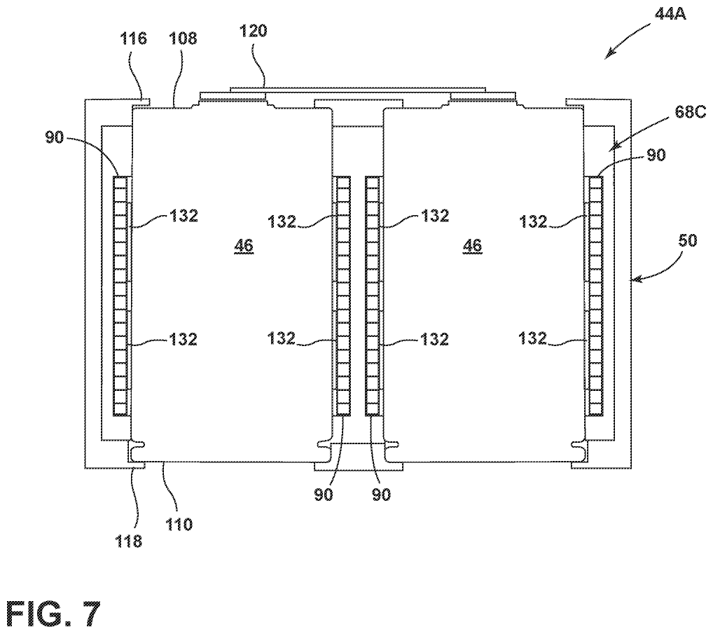

FIG. 7 illustrates a partial schematic side view taken from FIG. 4 to illustrate the preformed insert 68C having the unitary configuration with coolant ribbons 90 in accordance with one non-limiting aspect of the present disclosure. The coolant ribbons 90 may be similar to the above-described coolant ribbons 90, which are shown to be optionally disposed relative to a thermal interface material 132. The thermal interface material 132 may be disposed between the coolant ribbons 90 in the battery cells 46 for supporting thermal conductivity therebetween. The coolant ribbons 90 may optionally be contained mediums separated from the battery cells 46 such that contact between the coolant therein and the battery cells 46 may be avoided, i.e., the coolant may flow through the ribbons 90 to thermally conductive heat away from the battery cells 46 without being immersed with or otherwise contacting the battery cells 46. The capability to cycle coolant through the coolant ribbons 90 may be advantageous in limiting the likelihood of the coolant leaking out from the preformed insert 68C and/or to ease manufacturability of the preformed insert 68C by permitting the insert 68C to be formed without requiring the protuberances and/or the seals noted above.

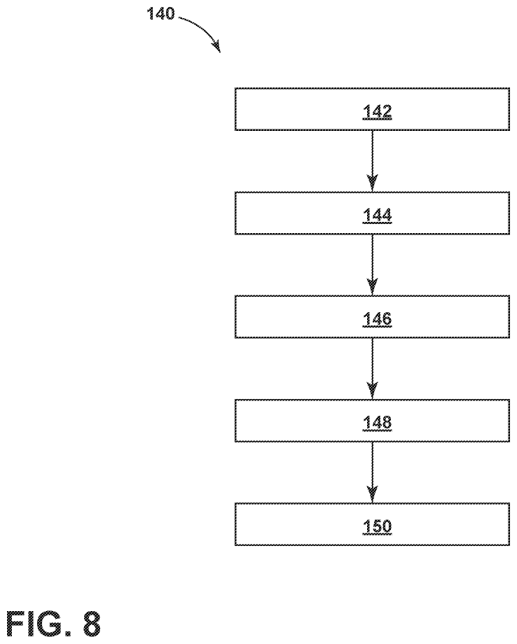

FIG. 8 illustrates a flowchart 140 of a method for manufacturing a battery module 44 in accordance with one non-limiting aspect of the present disclosure. Block 142 relates to a forming process whereby the preformed insert 68 may be formed. The forming process may include forming the preformed insert 68 such that the cell cavities 70 include an upper end, a lower end, and a middle portion between the upper and lower ends, with the upper and lower ends being narrower than the middle portions and the middle portions defining the coolant channels 72. The forming process may include forming the preformed insert 68C such that the battery cells 46 are arranged into a plurality of rows and the middle portions of the cavities 70 in each respective row fluidly interconnect with each other to define the coolant channels 72. The forming process may include forming the preformed insert 68 out of a thermally conductive material having a closed-cell foam structure. Block 144 relates a process for receiving and/or manufacturing a cell holder 50. Block 146 relates a process for receiving a plurality of battery cells 46. Block 148 relates to an assembly process for positioning a preformed insert 68 within the cell holder 50 and thereafter or in concert therewith pressing fitting or otherwise inserting the battery cells 46 into a respective one of the cell cavities 70. The assembly process may optionally be performed by securing the battery cells 46 within the preformed insert 68 and securing the preformed insert 68 within the cell holder 50 without use of a poured epoxy or a fluid adhesive.

As supported above, the present disclosure relates to a preformed cell-to-cell barrier potting material molded with built-in channels that provide cooling function for cells within a battery module. The cell-to-cell barrier material may be formed as a part that can be assembled during battery module manufacturing to reduce manufacturing cost and cycle time by eliminating need for injection machines, inventory for potting cure time in assembly line, etc. The potting material may be formed with built-in channels for dielectric coolant flow to enable immersion cooling without a mass penalty of large coolant volume within the battery module. The potting material may be a preformed closed-cell foam material that provides thermal and electrical barrier between cells. The potting material may be shaped to enclose coolant flow channels that replace cold plate and/or cooling ribbons and interface directly with rest of the cooling system (pumps, filters, hoses, heat exchangers). The potting material may be shaped to form cavities for receiving battery cells and/or other types have energy cells having cylindrical, prismatic, pouch, or other shapes and/or sizes, with coolant channels shaped relative thereto.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A battery module, comprising:
a plurality of battery cells configured for storing and supplying electrical power;
a cell holder configured for supporting the battery cells; and
a preformed insert disposed relative to the cell holder and the battery cells, the preformed insert including a potting material shaped to define a plurality of coolant channels for the battery cells.

2. The battery module according to claim 1, wherein:
the preformed insert includes a plurality of cell cavities fluidly interconnected with the coolant channels, wherein the cell cavities are shaped within the potting material to laterally surround a respective one of the battery cells.

3. The battery module according to claim 2, wherein:
the preformed insert includes a two-piece construction having an upper part preformed separately from a lower part and an interlock configured for attaching the upper part to the lower part.

4. The battery module according to claim 2, wherein:
the cell cavities include an upper end proximate a top of the battery cells and a lower end proximate a bottom of the battery cells; and
the preformed insert is configured to provide an upper interference fit between the upper ends and the top of the battery cells and a lower interference fit between the lower ends and the bottom of the battery cells.

5. The battery module according to claim 4, wherein:
the upper and lower interference fits are provided with respective upper and lower protuberances formed within the potting material.

6. The battery module according to claim 4, wherein:
the upper and lower interference fits are provided with respective upper and lower o-rings and/or gaskets disposed within the potting material.

7. The battery module according to claim 2, wherein:
the preformed insert includes a plurality of coolant ribbons disposed within the coolant channels, wherein the coolant ribbons define coolant passageways for coolant to flow through the coolant channels.

8. The battery module according to claim 7, wherein:
the preformed insert includes a thermal interface material disposed between the coolant ribbons and the battery cells, wherein the thermal interface material is configured for supporting thermal conductivity between the coolant ribbons and the battery cells.

9. The battery module according to claim 2, wherein:
the potting material includes a thermally conductive material having a closed-cell foam structure.

10. The battery module according to claim 2, wherein:
the cell cavities include an upper end proximate a top of the battery cells, a lower end proximate a bottom of the battery cells, and a middle portion between the upper and lower ends, wherein the upper and lower ends are narrower than the middle portions and the middle portions define the coolant channels.

11. The battery module according to claim 10, wherein:
the battery cells are arranged into a plurality of rows; and
the coolant channels are shaped such that the middle portions of the cavities in each respective row fluidly interconnect.

12. The battery module according to claim 11, wherein:
the cell holder includes a coolant inlet and a coolant outlet, wherein the coolant inlets and outlets fluidly interconnect with respective middle portions of the cell cavities.

13. A method for manufacturing a battery module, comprising:
positioning a preformed insert within a cell holder, the preformed insert including a potting material formed to define a plurality of cell cavities interspersed relative to a plurality of coolant channels; and
pressing a plurality of battery cells into a respective one of the cell cavities.

14. The method according to claim 13, further comprising:
forming the preformed insert such that the cell cavities each include an upper end, a lower end, and a middle portion, wherein the middles portions are between the upper and lower ends, narrower than the upper and lower ends, and define the coolant channels.

15. The method according to claim 14, further comprising:
forming the preformed insert such that the battery cells are arranged into a plurality of rows and the middle portions of the cavities in each respective row fluidly interconnect with each other to define the coolant channels.

16. The method according to claim 15, further comprising:
forming the preformed insert out of a thermally conductive material having a closed-cell foam structure.

17. The method according to claim 16, further comprising:
securing the battery cells within the preformed insert and securing the preformed insert within the cell holder without use of a poured epoxy or a fluid adhesive.

18. A vehicle, comprising:
an electric motor configured for converting electrical power to mechanical power suitable for use in propelling the vehicle; and
a rechargeable energy storage system (RESS) having one or more energy modules configured for storing and supplying the electrical power, wherein the energy modules respectively include:
a plurality of energy cells configured for storing and supplying the electrical power;
a cell holder configured for supporting the energy cells;
a preformed insert having a potting material shaped to define a plurality of cell cavities for receiving the energy cells and a plurality of coolant channels for defining passageways for coolant to flow between the cell cavities relative to the energy cells;
a busbar configured for electrically interconnect the energy cells, the busbar connecting to a portion of the energy cells extending beyond a top surface of the preformed insert; and
a coolant system configured for cycling the coolant through the coolant channels to facilitate conducting thermal energy away from the energy cells.

19. The vehicle according to claim 18, wherein:
the energy cells are cylindrically shaped battery cells; and
the potting material is molded from thermally conductive material having a closed-cell foam structure.

20. The vehicle according to claim 19, wherein:
the cell cavities are through-holes shaped to include an upper end, a lower end, and a middle portion, with the upper and lower ends being narrower than the middle portions and the middle portions defining the coolant channels.
